(19) United States
(12) Patent Application Publication
(10) Pub. No.: US 2017/0171591 A1
(43) Pub. Date: Jun. 15, 2017

(54) Unilateral Transmission Of Second Screen Information In Proximity Of A First Screen

(71) Applicant: THOMSON LICENSING, Issy de Moulineaux (FR)

(72) Inventors: Ajith Pudhiyaveetil, Santa Clara, CA (US); Nadia Fawaz, Santa Clara, CA (US); Hossein Abadl, Palo Alto, CA (US); Arshit Gupta, Pittsburg, PA (US); Kevin Xu, Toledo, OH (US); Yan Li, Warren, MI (US); Yun-Jhong Wu, Ann Arbor, MI (US); William Trouleau, Gex (FR)

(21) Appl. No.: 14/969,538

(22) Filed: Dec. 15, 2015

(51) Int. Cl. H04N 21/414; H04N 21/41; H04N 21/81; H04N 21/214

(52) U.S. Cl. CPC H04N 21/41407; H04N 21/2143; H04N 21/4122; H04N 21/4126; H04N 21/41415; H04N 21/812

(57) ABSTRACT

A receiver on a mobile device accepts at least one unrequested signal from a transmitter located in proximity of a first screen showing a first multimedia content. The received signal contains information associated with a second multimedia content shown on a second screen. The information can trigger an application residing on the mobile device based on the characteristics of the received signal. The information is accepted by the application which then generates second screen information associated with a displaying of a second multimedia content on a second screen, the generation of the second screen information based upon the information, reception of the transmitted signal and a location of the second screen.

### TECHNICAL FIELD

The present principles relate to multimedia content. In particular, the present principles relate to beacon signals that relay information about content on a second screen while in the vicinity of a first screen, the relayed information dependent on content on the first screen.

### BACKGROUND

Movie theatres have been providing movie entertainment to the general public for many years. Audience members, however, now have other choices of venues for viewing entertainment, such as a home environment. When people do travel to the theaters, they are essentially in a “captive” environment for the duration of the feature movie. Thus, it can be an opportune time to disseminate information relating to multimedia content and the like.

### SUMMARY

A transmitter or beacon is employed in the vicinity of a screen that is capable of displaying content. The beacon unilaterally transmits information related to content on a second screen. The information is also based on content that is or will be displayed on the first screen. Reception of the transmitted signal can be accomplished via mobile devices such as smartphones, laptops, etc. The transmitted information includes data that can trigger one or more applications residing on the mobile device. This permits the application(s) to accept the data as an input and generate information associated with the display of multimedia content on a second screen. The generation of the second screen information is based upon the received data and the location of the second screen.

In one example, movie goers today have the option of watching movies at public movie theatres or at home using VOD services. However, keeping track of the movies showing in VOD and the theatre can be burdensome. Users need to browse the movie titles in VOD and lookup the titles showing at the theatre. As noted above, some movies are made available in VOD while still showing in theatres, but this information is not readily available. Furthermore, users may like to be informed about products or discounts related to movies they watch at the theatre. When they attend a movie at the movie theater, their mobile devices can receive a signal that triggers a VOD application on their phone. Information regarding multimedia content being shown on another theater screen or even multimedia content being shown in another venue can be generated based upon the received input data.

The aspects, features and advantages of the present principles will be appreciated when considered with reference to the following description of examples and accompanying figures. The following description does not limit the present principles; rather, the scope of the present principles is defined by the appended claims and equivalents.

### BRIEF DESCRIPTION OF THE DRAWINGS

FIG. 1 is an exemplary mobile device and transmitter in accordance with embodiments of the present principles.

FIG. 2 is an exemplary method of triggering an application in a mobile device in accordance with embodiments of the present principles.

FIG. 3 is a use case example in accordance with embodiments of the present principles.

FIG. 4 is a further use case example in accordance with embodiments of the present principles.

FIG. 5 is another flow diagram of an exemplary method in accordance with embodiments of the present principles.

FIG. 6 is another working example in accordance with embodiments of the present principles.

FIG. 7 is yet a further flow diagram of an exemplary method in accordance with embodiments of the present principles.

FIG. 8 illustrates a further working example in accordance with embodiments of the present principles.

### DETAILED DESCRIPTION

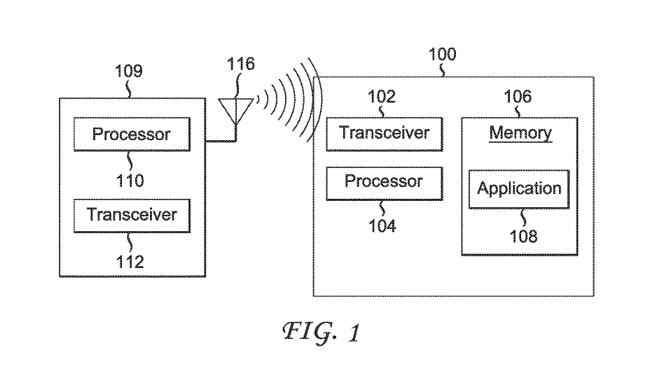

FIG. 1 presents a schematic diagram of an illustrative mobile device 100 and transmitter 109 in accordance with aspects of the present principles. Mobile device 100 can comprise, as non-limiting examples, any mobile device capable of processing instructions and transmitting data to and from other computers, including a laptop, a smartphone or tablet PC and the like. Mobile device 100 can include all the components normally used in connection with a mobile device. For example, mobile device 100 can have, for example, a touch screen display, a physical keyboard, a virtual touch screen keyboard, a camera, a speaker, a global positioning system, or a microphone.

Mobile device 100 can also contain at least one processor that can be arranged as different processing cores. For ease of illustration, one processor 104 is shown in FIG. 1, but it is understood that multiple processors can be employed simultaneously. Processor 104 can be any number of well-known processors, such as processors from Intel® Corporation. In another example, processor 104 can be an application specific integrated circuit (“ASIC”). Processor 104 can be implemented as a hardware processor, a digital signal processor (“DSP”), an ASIC, a field programmable gate array (“FPGA”) or other programmable logic devices, a discrete gate or transistor logic device, a discrete hardware component, or any suitable combination of processing circuitry. Processor 104 can also be implemented as a combination of computation devices, such as a combination of a DSP and a microprocessor, a plurality of microprocessors, one or more microprocessors in communication with the DSP or any other such configuration. The described devices can include processing circuits, processors, FPGAs or ASICs, each of which can be in combination with software for execution.

Memory 106 can be any type of memory capable of storing information accessible by processor 104 including, but not limited to, a memory card, read only memory (“ROM”), random access memory (“RAM”), as well as other write-capable and read-only memories. Mobile device 100 can include different combinations of the foregoing, whereby different portions of the instructions and data are stored on different types of media.

In another example, memory 106 can be a non-transitory computer readable medium that can include any computer readable media with the exception of a transitory, propagating signal. Examples of non-transitory computer readable media can include one of many physical media such as, for example, electronic, magnetic, optical, electromagnetic, or semiconductor media. More specific examples of suitable non-transitory computer-readable media include, but are not limited to, a portable universal serial bus (“USB”) drives, an erasable programmable read-only memory, or other storage devices that can be coupled to mobile device 100 directly or indirectly. The non-transitory computer readable media can also include any combination of one or more of the foregoing and/or other devices as well. While only one memory is shown in FIG. 1, mobile device 100 can actually comprise additional memories that may or may not be stored within the same physical housing or location.

Transceiver 102 can include hardware components (e.g., chipsets, controllers, antennas, etc.) and/or software that allow mobile device 100 to transmit and/or receive data. Transceiver 102 can support one or more network interfaces including, but not limited to, Wi-Fi™, worldwide interoperability for microwave access (“WiMAX™”), 3rd generation mobile telecommunications (“3G”), 4^{th} generation mobile telecommunications (“4G”), code division multiple access (“CDMA”), time division multiple access (“TDMA”), global system for mobile communications (“GSM”), Ethernet, special protocols proprietary to one or more companies, and various combinations of the foregoing, for example. Transceiver 102 can also support short range wireless protocols, such as Bluetooth® and/or Bluetooth® Smart and similar.

Application 108 can include software instructions for executing functions on the mobile device 100 and external to the mobile device 100. Examples are described further below. However, it is understood that application 108 can be implemented in the form of hardware and software combined and that the examples herein are merely illustrative. In the software implementation, application 108 can be encoded in any set of software instructions that are executable directly (such as machine code) or indirectly (such as scripts) by processor 104. The computer executable instructions can be stored in any computer language or format, such as in object code or modules of source code.

Transmitter 109 can be an apparatus with circuitry for transmitting a unilateral signal. The architecture of processor 110 and transceiver 112 can be similar to that of processor 104 and transceiver 102 respectively. Transmitter 109 can also be equipped with an antenna 116 to broadcast electromagnetic waves with a specific length and frequency such as, for example, 2.4 GHz radio waves. In one example, the shape and positioning of antenna 116 can be arranged to propagate a transmitted signal with more strength in a certain direction. The broadcasting power of transmitter 109 can be increased accordingly based on a desired range of the transmitter signal. Transmitter 109 can also support different wireless protocols including, but not limited to, Wi-Fi™, WiMAX™, Bluetooth® and/or Bluetooth® Smart.

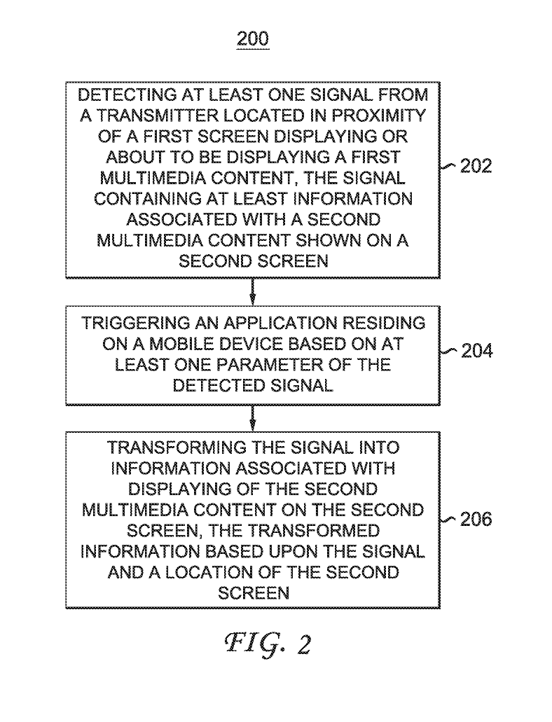

Looking at FIG. 2, an exemplary method of triggering an application in a mobile device in accordance with embodiments of the present principles is shown. The mobile device 100 detects at least one signal from transmitter 109 which is located in proximity of a first screen 202. The first screen is displaying or about to display a first multimedia content. This initiates the transmitter 109 to begin transmitting the signal that is received by the mobile device 100. The signal transmitted by transmitter 109 contains, at least, information associated with a second multimedia content that is displayed or is going to be displayed on a second screen. In one basic example of an embodiment, the first screen can be showing the latest Star Wars movie. The second screen, can be, but is not required to be, in the same movie theater complex as the first screen. The second screen may be displaying or about to display the original Star Wars movie. In this example, the signal can contain information to inform a user of the mobile device 100 that the original Star Wars movie is being shown in one of the other movie theater screens at the movie theater complex. Since the transmitter 109 is in proximity of the first screen, the information about the second screen is only transmitted to those users of mobile devices that have an interest in Star Wars movies (e.g., transmitted to those in proximity of a first screen whose first multimedia content is associated with a second multimedia content on a second screen).

The transmitted signal triggers an application 108 residing on the mobile device 100 based on at least one parameter of the detected signal. The parameter can be, for example, coded bits in a header portion of a message encoded in the signal and the like. This triggers or awakens the application 108 to perform and/or provide functions associated with the second multimedia content being displayed or about to be displayed on the second screen. The application 108 can transform the signal into information associated with the displaying or about to be displaying of the second multimedia content on the second screen 206. The transformed information is based on the received signal sent by the transmitter 109 and a location of the second screen. For example, if the second screen is located in the same movie theater complex as the first screen, the application 108, using the information that the second screen is displaying or about to display the original Star Wars movie, search and find information about movie start times for the second screen. The application 108 might then notify a user that they can watch the original Star Wars movie on the second screen after watching the latest Star Wars movie on the first screen. One skilled in the art can appreciate that the location of the second screen can also be a user's home television and the like. Thus, the application 109 can include, but is not limited to, a video on demand service and the like. The application 109 can determine that all of the earlier Star War movies are available for watching from home and notify the user of times and dates when they are available. The application 109 can also store the information in user available listings and the like as described in the next example.

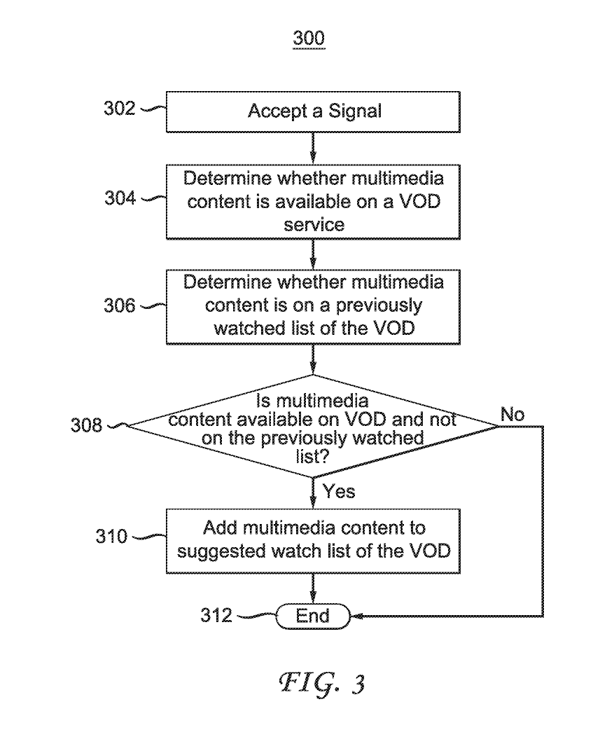

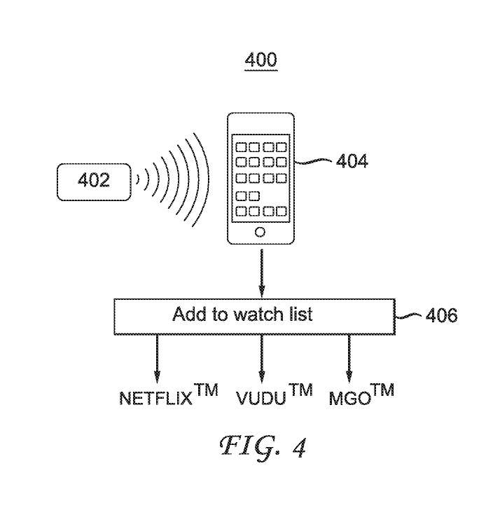

One working example of the techniques herein is shown in FIGS. 3-4. This example illustrates how a video on demand (VOD) application on a mobile device can be implemented to provide a user additional functionality and/or features and the like. In particular, FIG. 3 illustrates a flow diagram of an exemplary method 300 for triggering an application in a mobile device, and FIG. 4 illustrates an exemplary method of triggering an application while approaching or near a first screen playing a first multimedia content. The actions shown in FIG. 4 will be discussed below with regard to the flow diagram in FIG. 3.

Referring now to FIG. 3, a unilateral signal can be accepted as shown in block 302. Referring now to FIG. 4, mobile device 404 is shown receiving a signal from transmitter 402. In this example, it is assumed that mobile device 404 and the transmitter 402 are in proximity to a first screen displaying or about to display a first multimedia content. Thus, mobile device 404 can receive a signal as a user approaches or is near the first screen.

Referring back to FIG. 3, in response to the unilateral signal, mobile device 404 of FIG. 4 can determine whether a second multimedia content being played or about to be played on a second screen is available on a VOD service, as shown in block 304 of FIG. 3. Referring back to FIG. 4, instructions in the VOD application executing in mobile device 404 can instruct its processor to find information regarding the theatre at the location of mobile device 404 and retrieve a list of movies showing at the theatre. The location of the mobile device can be obtained using global positioning technology and/or WiFi locating and the like as well as from user input.

In block 306 of FIG. 3, mobile device 404 can determine whether the second multimedia content showing at the second screen is on a previously watched list of the VOD service. If the second multimedia content is available in VOD and the second multimedia content is not on a previously watched list, as shown in block 308, the second multimedia content can be added to a watch list of the VOD, as shown in block 310; otherwise, the process can end at block 312. Referring back to FIG. 4, instructions in the VOD application executing in mobile device 404 can instruct its processor to add the second multimedia content being shown in the theatre, as shown in block 406, to a watch list of a VOD service, such as Netflix™, Vudu™, MGo™ and/or the like.

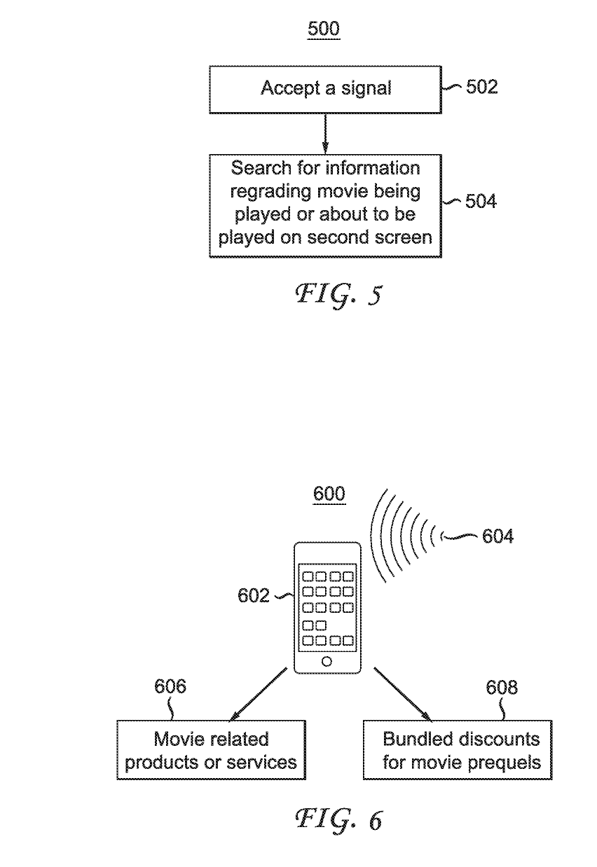

Another example of the present principles is shown in FIGS. 5 and 6. In particular, FIG. 5 illustrates a flow diagram of an exemplary method 500 for triggering VOD functionality related to a particular movie. FIG. 6 illustrates a working example of the functionality being executed. The actions shown in FIG. 6 will be discussed below with regard to the flow diagram in FIG. 5.

In FIG. 5, a unilateral signal can be accepted at block 502. The signal can comprise an identifier associated with a second movie being played or about to be played on a second screen from a first screen which a mobile device is currently in proximity with. As will be discussed further below, the signal transmitter is located in proximity to the first screen. In response to the signal, information regarding the second movie being played or about to be played can be searched, as shown in block 504.

Referring now to FIG. 6, mobile device 602 is shown receiving a unilateral signal 604 containing an identifier of a second movie being played or about to be played on a second screen of the theatre (or elsewhere). In response, the instructions of a VOD application in mobile device 602 is triggered and can instruct its processor to search for information regarding the second movie being played or about to be played on the second screen. In the example of FIG. 6, the information can include movie related products or services 606, or bundled discounts 608 from the VOD service for purchasing prequels of the movie, etc. However, it is understood that any other information regarding the second movie can be retrieved in response to this unilateral signal and that FIG. 6 is merely illustrative.

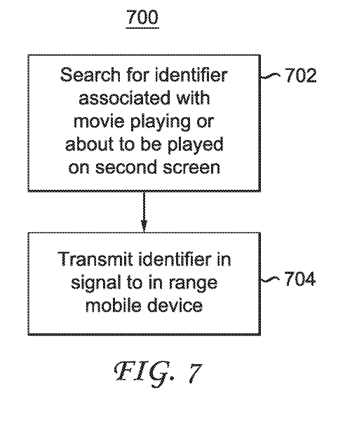

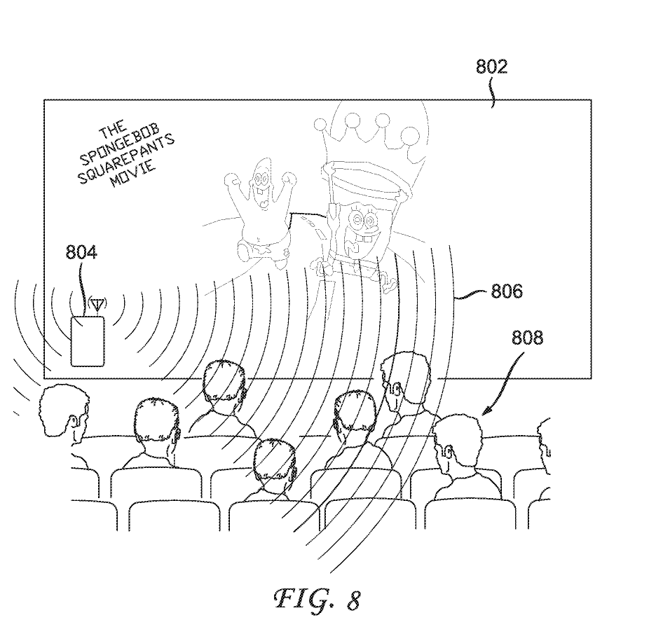

Yet a further example of the present principles is shown in FIGS. 7 and 8. In particular, FIG. 7 illustrates a flow diagram of an exemplary method 700 for transmitting a unilateral signal related to a second movie display or about to be displayed on a second screen. FIG. 8 illustrates a working example of the transmitter. The actions shown in FIG. 8 will be discussed below with regard to the flow diagram in FIG. 7.

Referring now to FIG. 7, an identifier associated with a second movie being played or about to be played on a second screen can be searched, as shown in block 702. Referring now to FIG. 8, a unilateral transmitter 804 is shown positioned on a first screen 802, but it is understood that the transmitter can be located within proximity of the first screen. The transmitter 804 shown in FIG. 8 can have similar components as the transmitter 109 shown in FIG. 1. The transmitter can search for the movie identifier in a wide area network (“WAN”) (e.g., the Internet or a cloud service) and/or a local area network (“LAN”) configured in the movie theatre. This can be accomplished by the transmitter 804 wirelessly and/or through wired communication means. Referring back to FIG. 7, the identifier can be transmitted in a unilateral signal to at least one mobile device within a transmission range of the transmitter, as shown in block 704. Referring back to FIG. 8, transmitter 804 is shown transmitting a unilateral signal 806 to audience members 808. The size, shape, broadcast power and/or location of the transmitter's antenna can be adjusted to ensure that audience members 808 viewing the first screen 802 receive the signal, without interfering with signals of neighboring movie screens. That is, the transmitter 804 can be adjusted so that all audience members 808 watching the first screen 802 are in range, while audience members watching neighboring screens are out of range.

Advantageously, the above-described devices and methods allow movie information from theatres to be combined with information from VOD services and the like. Furthermore, these techniques allow users to gain access to additional information related to movies being shown at the movie theatre. In this regard, a signal transmitted at theatres can cause a mobile device to activate enhanced features of an application on the mobile device to better inform the user of the mobile device. In turn, movie goers can be provided with a better user experience.

Although the present principles herein have been described with reference to particular examples in particular environments, it is to be understood that these examples are merely illustrative of the present principles. It is therefore to be understood that numerous modifications can be made to the examples and that other arrangements can be devised without departing from the scope of the present principles as defined by the appended claims. As noted above, the systems herein can be modified to operate in various settings, such as airplanes, cars, hospitals, nursing homes, or any other setting that may offer multimedia content services. Furthermore, while particular processes are shown in a specific order in the appended drawings, such processes are not limited to any particular order unless such order is expressly set forth herein. Rather, various steps may be handled in a different order or simultaneously, and steps may be omitted or added.

1. A mobile device comprising:
a receiver comprising circuitry to accept at least one unrequested signal responsive to a first screen displaying or about to display a first multimedia content, the signal containing at least information associated with a second multimedia content shown on a second screen; and
at least one processor configured to:
trigger an application based on at least one parameter of the received signal; and
transform the signal, using the application, into information associated with displaying of the second multimedia content on the second screen, the transformation based upon the signal and a location of the second screen.

2. The mobile device of claim 1, wherein at least one processor is further configured to:
determine whether the second multimedia content is on a previously watched list of a video on demand service; and
add the second multimedia content to a suggested watch list of the video on demand service, when the second multimedia content is available and the second multimedia content is not on the previously watched list.

3. The mobile device of claim 1, wherein the at least one processor is further configured to search, in response to the signal, for information regarding multimedia content being played or about to be played on the second screen.

4. The mobile device of claim 3, wherein the information includes prequels of the multimedia content being played or about to be played on the second screen.

5. The mobile device of claim 1, wherein the at least one processor is further configured to search a video on demand service for discounts associated with the multimedia content being played or about to be played on the second screen.

6. The mobile device of claim 1, wherein the signal comprises an identifier associated with the multimedia content being played or about to be played on the second screen.

7. A method comprising:
detecting, by a receiver, at least one signal responsive to a first screen displaying or about to be displaying a first multimedia content, the signal containing at least information associated with a second multimedia content shown on a second screen; and
triggering an application residing on a mobile device based on at least one parameter of the detected signal;
transforming the signal into information associated with displaying of the second multimedia content on the second screen, the transformed information based upon the signal and a location of the second screen.

8. The method of claim 7 further comprising:
determining whether the second multimedia content is on a previously watched list of a video on demand service; and
adding the second multimedia content to a suggested watch list of the video on demand service, when the second multimedia content is available and the second multimedia content is not on the previously watched list.

9. The method of claim 7, further comprising:
searching for information regarding multimedia content being played or about to be played on the second screen.

10. The method of claim 9, wherein the information includes prequels of multimedia content being played or about to be played on the second screen.

11. The method of claim 7, further comprising:
searching a video on demand service for discounts associated with the multimedia content being played or about to be played on the second screen.

12. A transmitter device, comprising:
transmitter circuitry to transmit a signal, wherein the transmitter is arranged in proximity to a first screen; and
at least one processor configured to:
determine a first multimedia content that is or will be played in proximity to the transmitter circuitry on a first screen;
obtain information associated with a second multimedia content that is or will be played on at least one other screen;
create at least one transmission signal that is embedded with at least a portion of the obtained information;
add application information to the at least one transmission signal to trigger an application on a mobile device that is in proximity of the transmitter; and
transmit the signal using the transmitter circuitry based on the playing or about to be playing of the first multimedia content.

13. The transmitter of claim 12, wherein the at least one processor is further configured to search periodically for updates regarding the first multimedia content being played or about to be played on the second screen.

14. A method comprising:
determining a first multimedia content that is or will be played on a first screen;
obtaining information associated with a second multimedia content that is or will be played on at least one other screen;
creating at least one transmission signal that is embedded with at least a portion of the obtained information;
adding application information to the at least one transmission signal to trigger an application on a mobile device; and
transmitting the signal using the transmitter based on the playing or about to be playing of the first multimedia content.

15. The method of claim 14, further comprising:
searching periodically, by the transmitter, for updates regarding the multimedia content being played or about to be played on the second screen.
